(19) United States
(12) Patent Application Publication
(10) Pub. No.: US 2013/0207392 A1
(43) Pub. Date: Aug. 15, 2013

(54) SYSTEM AND METHOD FOR OPERATING WIND FARM

(71) Applicant: Timothy E. McCorkendale, California City, CA (US)

(72) Inventor: Timothy E. McCorkendale, California City, CA (US)

(73) Assignee: GENERAL ELECTRIC COMPANY, Schenectady, NY (US)

(21) Appl. No.: 13/396,832

(22) Filed: Feb. 15, 2012

(51) Int. Cl. F03D 9/00

(52) U.S. Cl. 290/44

(57) ABSTRACT

Systems and methods for operating a wind farm are disclosed. The wind farm includes a wind generator. The method includes detecting an atmospheric condition at a location spaced apart from the wind generator, and communicating a control signal to the wind generator. The control signal is based on the atmospheric condition. The method further includes adjusting the wind generator according to the control signal before the atmospheric condition is experienced by the wind generator.

### FIELD OF THE INVENTION

The present disclosure relates generally to the field of wind farms, and more particularly, to systems and methods for adjusting wind generators in the wind farm based on detected atmospheric conditions.

### BACKGROUND OF THE INVENTION

Wind power is considered one of the cleanest, most environmentally friendly energy sources presently available, and wind generators have gained increased attention in this regard. A modern wind generator typically includes wind turbine and a generator. The wind turbine typically includes a tower, gearbox, nacelle, and one or more rotor blades. The generator is typically housed in the nacelle. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid. Further, wind generators are typically grouped together in a wind farm, and may be onshore or offshore.

Typically, a wind generator is adjusted during operation to obtain optimal loading while avoiding excess loads due to, for example, wind gusts. For example, known wind generators may include atmospheric detection apparatus, such as wind vanes and anemometers, mounted on the wind turbine. Changes in atmospheric conditions, such as wind speed and direction, are experienced by the wind generator and simultaneously or soon thereafter detected by the atmospheric detection apparatus. The wind generator is then adjusted as required based on these experienced atmospheric conditions. For example, the pitch of the rotor blades, the yaw of the wind generator, and/or the torque of the generator may be adjusted.

However, the use of atmospheric detection apparatus mounted on wind generators and the detection thereby of experienced atmospheric conditions have a variety of disadvantages. For example, because the atmospheric conditions that are detected are already experienced by the wind generators, any changes in atmospheric conditions may affect the wind generators prior to adjustment thereof. Such changes in atmospheric conditions can thus damage the wind generators, particularly in the case of increased wind speeds, which can cause excess loading prior to detection and adjustment.

Accordingly, improved systems and methods for operating wind farms would be advantageous. For example, systems and methods that provide for anticipatory detection of atmospheric conditions and adjustment of wind generators would be desired.

### BRIEF DESCRIPTION OF THE INVENTION

Aspects and advantages of the invention will be set forth in part in the following description, or may be obvious from the description, or may be learned through practice of the invention.

In one embodiment, a method for operating a wind farm is disclosed. The wind farm includes a wind generator. The method includes detecting an atmospheric condition at a location spaced apart from the wind generator, and communicating a control signal to the wind generator. The control signal is based on the atmospheric condition. The method further includes adjusting the wind generator according to the control signal before the atmospheric condition is experienced by the wind generator.

In another embodiment, a system for operating a wind farm is disclosed. The system includes a wind generator and an atmospheric detection station spaced apart from the wind generator. The atmospheric detection station is configured to detect an atmospheric condition. The system further includes a control system in communication with the atmospheric detection station and the wind generator. The control system is configured to produce a control signal based on the atmospheric condition and communicate the control signal to the wind generator. The wind generator is adjustable according to the control signal before the atmospheric condition is experienced by the wind generator.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a wind turbine according to one embodiment of the present disclosure;

FIG. 2 is a schematic diagram of a wind farm according to one embodiment of the present disclosure; and,

FIG. 3 is a schematic diagram of a wind farm according to another embodiment of the present disclosure;

Repeat use of reference characters throughout the present specification and appended drawings is intended to represent same or analogous features or elements of the invention.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention encompass such modifications and variations as come within the scope of the appended claims and their equivalents.

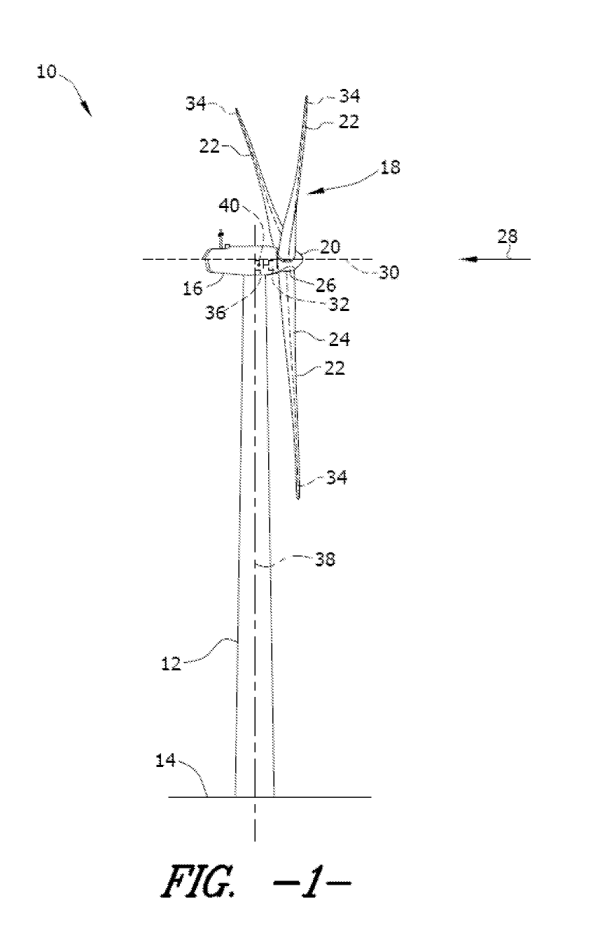

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support surface 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support surface 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26. In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position. Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18. Such pitching (of blades individually and in combination) and otherwise adjusting of the rotor blades 22 and wind turbine 10 can decrease loading in both the blades 22 as well as in other components of the wind turbine 10. For example, torque and bending loads in a main shaft connecting the rotor 18 and a generator (discussed below) may be reduced, and bending of the tower 12 may be reduced. This can increase the life of these components and/or reduce the costs associated with wind turbine 10 design and operation.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

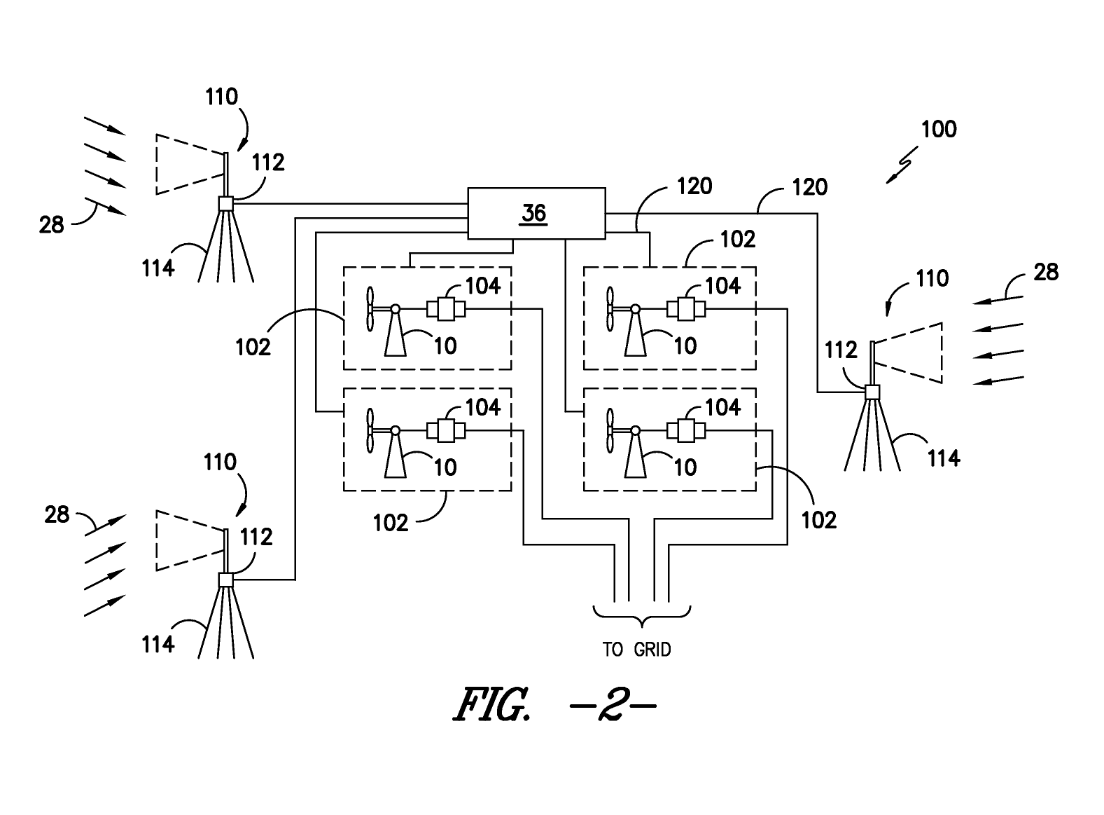

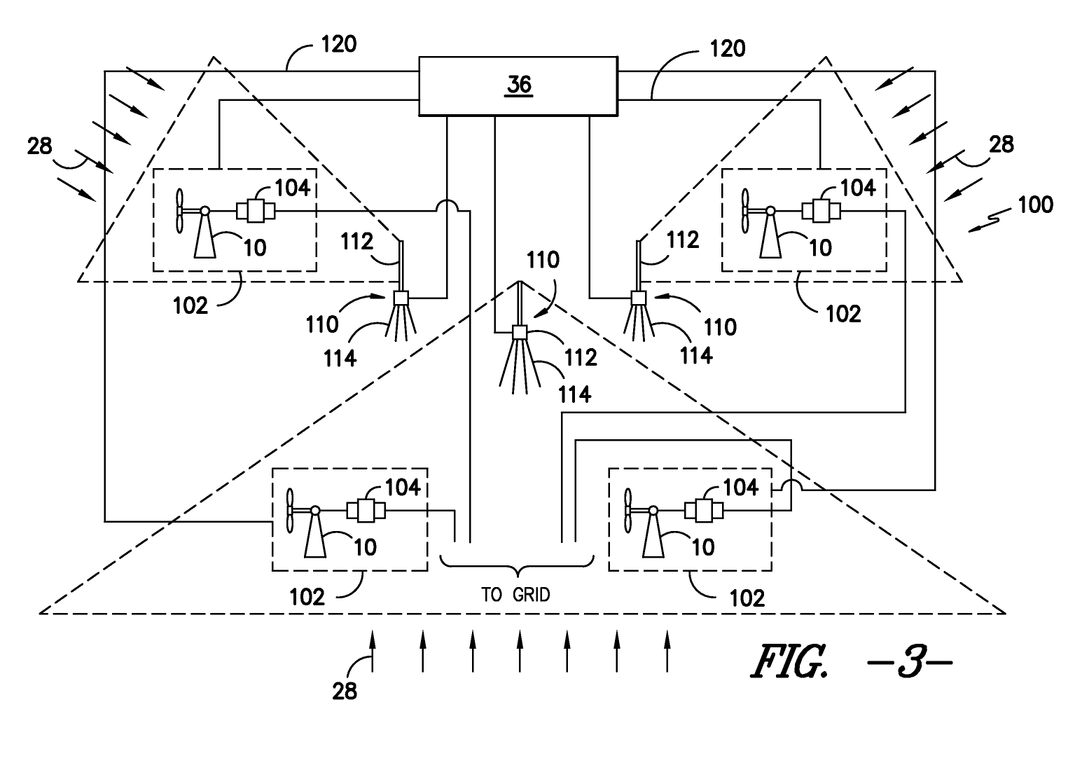

In FIG. 1, control system 36 is shown as being centralized within nacelle 16, however, control system 36 may be a distributed system throughout wind turbine 10, on support surface 14, central to a plurality of wind turbines 10 in a wind farm (as shown in FIGS. 2 and 3), and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

Referring now to FIGS. 2 and 3, a schematic diagram of a wind farm 100 is illustrated. The wind farm 100 includes one or more wind generators 102. A wind generator 102 according to the present disclosure includes, for example, one or more wind turbines 10 and one or more generators 104.

A wind turbine 10 and generator 104 in a wind generator 102 are coupled such that mechanical energy of the wind turbine 10 is supplied to the generator 102. The generator 104 may then store this energy and/or deploy the energy as desired or required. Typically, the rotor blades 22 of the wind turbine 10 transmit mechanical energy in the form of rotational energy so as to turn a shaft (not shown) coupling the rotor blades 22 to a gearbox (not shown), or if a gearbox is not used, directly to the generator 104. The generator 104 then converts the mechanical energy to electrical energy that may be deployed to a utility grid. To convert the mechanical energy to electrical energy, a generator stator (not shown) may be rotated with respect to a generator stator (not shown) due to rotation of the rotor blades 22.

A generator 104 for a wind generator 102 is typically housed in the nacelle 16 of the associated wind turbine 10. Alternatively, however, the generator 102 could be disposed outside of the nacelle 16 at any suitable location on or separate from the associated wind turbine 10.

As discussed, wind generators 102 are included in a wind farm 100. When more than one wind generator 102 is included in a wind farm 100, the wind generators 102 can have any suitable arrangement relative to one another. For example the wind generators 102 can be arranged in rows and/or columns, have any other suitable pattern, or be randomly arranged in the wind farm 100.

A wind farm 100 according to the present disclosure further includes one or more atmospheric detection stations 110. Each atmospheric detection station 110 is configured to detect atmospheric conditions. An atmospheric condition according to the present disclosure includes wind, climate, and other atmospheric conditions that may affect the performance of a wind generator 102. For example, an atmospheric condition may be the direction 28 of wind, the speed of wind, the wind shear (difference in the speed of wind between an upper location and a lower location, such as between the top and bottom of a rotor 18) or the wind veer (difference in the speed of wind between two sideways locations, such as between the left and right side of a rotor 18).

An atmospheric detection station 110 includes an atmospheric detection device 112. The atmospheric detection device 112 includes suitable hardware and software, such as a processor configured to perform the methods and/or steps described herein, for detecting, storing, and transmitting atmospheric conditions and data generated therefrom.

The device 112 in exemplary embodiments as shown may be a Light Detection and Ranging (“LIDAR”) device. LIDAR in general is an optical remote sensing technology. A LIDAR device can measure various properties of a target area by illuminating the target with light, such as with laser pulses. Exemplary target areas are shown in FIGS. 2 and 3 by dotted lines extending from the devices 112. Suitable LIDAR devices for detecting atmospheric conditions include, for example, Doppler LIDAR devices, Synthetic Array LIDAR devices, and Differential Absorption LIDAR devices.

Another suitable atmospheric detection device 112 is a Sonic Detection and Ranging (“SODAR”) device. A SODAR device in general can measure the scattering of sound waves due to atmospheric turbulence, and can be used to measure, for example, wind speeds, the thermodynamic structure of the atmosphere, and other various atmospheric conditions. A suitable SODAR device for detecting atmospheric conditions is, for example, a Doppler SODAR device.

Other suitable atmospheric detection devices 112 include, for example, anemometers, such as cup anemometers; wind vanes; barometers; and radar devices, such as Doppler radar devices. Further, it should be understood that the present disclosure is not limited to the above disclosed atmospheric detection devices 112, and rather that any other suitable devices that can detect atmospheric conditions that may affect the performance of a wind generator 102 are within the scope and spirit of the present disclosure.

An atmospheric detection station 110 may additionally include a tower or other suitable support apparatus 114. The support apparatus 114 may support the atmospheric detection device 112 at a suitable height for atmospheric detection.

Each atmospheric detection station 110 according to the present disclosure is disposed at a location that is spaced apart from each wind generator 102. Thus, the systems 110 are not mounted on any component of the wind generators 102. Each system 110 can thus advantageously detect atmospheric conditions, and changes therein, at these spaced apart locations and before these conditions reach one or more of the wind generators 102. Such anticipatory detection of atmospheric conditions allows the wind generators 102 to be adjusted as required to accommodate for the upcoming atmospheric conditions before experiencing the atmospheric conditions. Thus, for example, wind gusts, increases or decreases in wind speed, or changes in wind direction can be detected, and the wind generators 102 can be adjusted to accommodate these changes in loading before the changes reach the wind generators 102. Such anticipatory detection and adjustment may, for example, advantageously mitigate potential wind generator 102 damage from, for example, excess loading due to the wind generator 102 not being adjusted before experiencing changes in atmospheric conditions.

In some embodiments, as shown in FIG. 2, an atmospheric detection station 110 may be located upstream of an associated wind generator 102 with respect to the direction of flow of the incoming atmospheric conditions. These atmospheric detection stations 110 may detect atmospheric conditions upstream of the associated wind generator 102 until these atmospheric conditions pass the atmospheric detection station. In other embodiments, as shown in FIG. 3, an atmospheric detection station 110 may be located downstream of an associated wind generator 102 with respect to the direction of flow of the incoming atmospheric conditions. These atmospheric detection stations 110 may detect atmospheric conditions upstream of the associated wind generator 102 until as well as after these atmospheric conditions pass the associated wind generator 102. Further, it should be understood that the present disclosure is not limited to any particular locations for the atmospheric detection stations 110 with respect to the associated wind generators 102, provided that the atmospheric detection stations 110 are spaced apart from the wind generators 102 and can detect atmospheric conditions.

An atmospheric detection station 110 may in exemplary embodiments be located a specified distance from an associated wind generator 102. This specified distance may allow for an atmospheric condition, or change thereof, to be communicated to the wind generator 102, and may further allow for the wind generator 102 to adjust as required. In some embodiments, the distance may be up to approximately 5 times the maximum diameter of the rotor 18 of the associated wind generator 102, or between approximately 0.1 times and approximately 5 times the maximum diameter of the rotor 18 of the associated wind generator 102. In other embodiments, the distance may be up to approximately 4 times, approximately 3 times, or approximately 2.5 times the maximum diameter, or between approximately 0.1 times and approximately 4 times, approximately 3 times, or approximately 2.5 times the maximum diameter. It should be understood, however, that the present disclosure is not limited to the above disclosed distances, and rather that any suitable distance is within the scope and spirit of the present disclosure.

To allow wind generators 102 to anticipatorily adjust before experiencing atmospheric conditions, the atmospheric conditions detected by atmospheric detection stations 110 are communicated to the wind generators 102. In particular, control signals based on the atmospheric conditions may be communicated to the wind generators 102. The wind generators 102 may be adjusted according to the control signals. Further, such adjustment may advantageously occur before the atmospheric conditions are experienced by the wind generators 102.

To facilitate communication of the atmospheric conditions and control signals, the control system 36 may be placed in communication with the atmospheric detection stations 110 and the wind generators 102. As shown, for example, a central control system 36 may be provided between the atmospheric detection stations 110 and the wind generators 102. Atmospheric conditions detected by the atmospheric detection stations 110 may be communicated to the control system 36, which may in turn produce control signals based on these atmospheric conditions. The control system 36 may thus be configured to produce control signals based on the atmospheric conditions. The control signals may provide for adjustment of the wind generators 102, and may be communicated to the wind generators 102 for adjustment thereof.

Communication devices 120 are provided to communicate atmospheric conditions to the control system 36 from the atmospheric detection stations 110, and to the wind generators 102 from the control system 36. In exemplary configurations, a communications device 120 may include, but is not limited to, wire, fiber optic, and/or wireless transmission such as radio communications.

As discussed, a wind generator 102 may be adjustable based on a control signal to anticipate atmospheric conditions. Any suitable adjustment may be made to the wind generator 102. Such adjustments alter how the wind generator 102 experiences atmospheric conditions. These adjustments may, for example, reduce, maintain, or increase the loading on the wind turbine 10 and various components thereof as desired or required. For example, in some embodiments, the pitch of the wind turbine 10, such as of one or more rotor blades 22 thereof, may be adjusted. In other embodiments, the yaw of the wind turbine 10, such as of the rotor 18 and/or nacelle 16 with respect to the tower 12, may be adjusted. In still other embodiments, the torque of the generator 104 may be adjusted. Still further, an adjustment of a wind generator 102 may include, for example, shutting the wind generator 102 down, cutting off power transfer between the wind generator 102 and the grid, or otherwise adjusting a characteristic of the wind generator 102 to alter how the wind generator 102 experiences atmospheric conditions. As discussed above, such adjustments according to the present disclosure are based on atmospheric conditions detected by atmospheric detection stations 110, and may be made before those atmospheric conditions, or changes therein, are experienced by the wind generators 102. Thus, when the atmospheric conditions reach and are experienced by the wind generator 102, the wind generator 102 has already been appropriately adjusted and is prepared to experience the atmospheric conditions. Further, such appropriate adjustments allow for potential damage to a wind generator 102 due to, for example, excess loading to be mitigated.

The present disclosure is further direction to methods for operating wind farms 100. A method includes, for example, detecting atmospheric conditions at locations spaced apart from wind generators 102. The atmospheric conditions may be detected by, for example, atmospheric detection stations 110 as discussed above. A method may further include communicating control signals to wind generators 102. The control signals may be based on the atmospheric conditions, and may be produced and communicated by a control system 36 as discussed above. A method may further include adjusting wind generators 102 according to the control signals. Such adjustment may occur before the atmospheric conditions are experienced by the wind generators 102.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a wind farm, the wind farm comprising a wind generator, the method comprising:
detecting an atmospheric condition at a location spaced apart from the wind generator;
communicating a control signal to the wind generator, the control signal based on the atmospheric condition; and,
adjusting the wind generator according to the control signal before the atmospheric condition is experienced by the wind generator.

2. The method of claim 1, wherein the atmospheric condition is one of wind direction and wind speed.

3. The method of claim 1, wherein the wind generator comprises a wind turbine and a generator, and wherein the adjusting step comprises adjusting one of wind turbine pitch and wind turbine yaw.

4. The method of claim 1, wherein the atmospheric condition is detected by a LIDAR system.

5. The method of claim 1, further comprising:
communicating the atmospheric condition to a control system; and,
producing from the control system a control signal based on the atmospheric condition.

6. The method of claim 1, further comprising detecting a plurality of atmospheric conditions at a plurality of locations each spaced apart from the wind generator.

7. The method of claim 1, wherein the wind farm comprises a plurality of wind generators.

8. A method for operating a wind farm, the wind farm comprising a plurality of wind generators, the method comprising:
detecting an atmospheric condition at a location spaced apart from the plurality of wind generators;
communicating a control signal to one of the plurality of wind generators, the control signal based on the atmospheric condition; and,
adjusting the one of the plurality of wind generators according to the control signal before the atmospheric condition is experienced by the one of the plurality of wind generators.

9. The method of claim 8, wherein the atmospheric condition is one of wind direction and wind speed.

10. The method of claim 8, wherein each of the plurality of wind generators comprises a wind turbine and a generator, and wherein the adjusting step comprises adjusting one of wind turbine pitch and wind turbine yaw.

11. The method of claim 8, wherein the atmospheric condition is detected by a LIDAR system.

12. The method of claim 8, further comprising:
communicating the atmospheric condition to a control system; and,
producing from the control system a control signal based on the atmospheric condition.

13. The method of claim 8, further comprising detecting a plurality of atmospheric conditions at a plurality of locations each spaced apart from the plurality of wind generators.

14. A system for operating a wind farm, the system comprising:
a wind generator;
an atmospheric detection station spaced apart from the wind generator, the atmospheric detection station configured to detect an atmospheric condition; and,
a control system in communication with the atmospheric detection station and the wind generator, the control system configured to produce a control signal based on the atmospheric condition and communicate the control signal to the wind generator,
whereby the wind generator is adjustable according to the control signal before the atmospheric condition is experienced by the wind generator.

15. The system of claim 14, wherein the atmospheric condition is one of wind direction and wind speed.

16. The system of claim 14, wherein the wind generator comprises a wind turbine and a generator, and wherein one of wind turbine pitch and wind turbine yaw is adjustable.

17. The system of claim 14, wherein the atmospheric detection station comprises a LIDAR system.

18. The system of claim 14, further comprising a plurality of atmospheric detection stations each spaced apart from the wind generator.

19. The system of claim 14, further comprising a plurality of wind generators.

20. The system of claim 14, wherein the control system is in communication with the atmospheric detection station and the wind generator through one of wire, fiber optical, and radio communication.
